(19) United States
(12) Patent Application Publication
(10) Pub. No.: US 2025/0011938 A1
(43) Pub. Date: Jan. 9, 2025

(54) METHOD FOR PRODUCING A POROUS TRANSPORT LAYER FOR AN ELECTROCHEMICAL CELL

(71) Applicant: Hoeller Electrolyzer GmbH, Wismar (DE)

(72) Inventor: Stefan HÖLLER, Lübeck (DE)

(21) Appl. No.: 18/888,477

(22) Filed: Sep. 18, 2024

Related U.S. Application Data
(63) Continuation of application No. 17/262,936, filed on Jan. 25, 2021, now abandoned.

(51) Int. Cl. C23C 24/08; C25B 9/23; C25B 9/65; H01M 8/0245

(52) U.S. Cl. CPC C23C 24/087; C25B 9/23; C25B 9/65; H01M 8/0245

(57) ABSTRACT

A method for manufacturing a porous transport layer (4) of an electrochemical cell includes mixing a metal powder with a binder and a subsequent shaping-out into a foil. The foil is brought to bear on a porous metal layer (8). The binder is subsequently removed and the remaining brown part layer (9) is sintered to the porous metal layer (8), so that a porous transport layer (4) is formed which includes a porous metal layer (8) with a microporous metal layer (9) which is deposited thereon.

### CROSS REFERENCE TO RELATED APPLICATIONS

This application is a continuation of, and claims the benefit of priority under 35 U.S.C. § 120 of U.S. patent application Ser. No. 17/262,936 filed Jan. 25, 2021, which is a United States National Phase Application of International Application PCT/EP2018/070458, filed Jul. 27, 2018, and the entire contents of which are incorporated herein by reference.

### TECHNICAL FIELD

The invention relates to a method for manufacturing a porous transport layer for an electrochemical cell, in particular for an electrolyzer of the PEM construction type, and specifically in particular for the electrolytic splitting of water into oxygen and hydrogen.

### TECHNICAL BACKGROUND

Porous transport layers, also known under the term PTL (porous transport layer) are applied for electrochemical cells, for example electrolyzers of the PEM construction type (PEM stands for proton exchange membrane and polymer electrolyte membrane), in order on the one hand to bring the reactant, e.g. water, onto the catalyzers and onto the PEMs of the cell stack formed from electrolyzers and on the other hand to lead the reaction products away again. Furthermore, these also have an essential electrical function, in order to lead a large as possible current onto the catalyzers on the cell membrane over a large surface or for example to lead such away from the membrane in the case e.g. of a fuel cell. Herein, for electrical reasons, it is desirable to form a closed as possible electrically conductive surface, in order to ensure an extensive (surfaced) and herewith intensive and uniform flow of current, whereas with regard to the reactant feed and the reaction product discharge, an open-pored as possible structure would be useful, in order to lead through the respective products with as little as possible energy effort. On the other hand, such porous transport layers should be as thin as possible, so that as many as possible electrochemical cells can be arranged in a cell stack of a given stack height. There are also applications, for example at the oxygen side in the case of a PEM electrolyzer for the catalytic electrolysis of water, concerning which with regard to the high material costs one constantly strives to realize such a porous transport layer with as little material expense as possible.

A method for manufacturing bipolar plates with integrated current distribution layers is already known from the state of the art from DE 10 2013 207 075 A1, concerning which the individual parts are connected to one another by way of sintering. In order to fulfil the aforementioned partly contradictory demands, it is known for example to use felts of a small thickness which are formed from titanium fibers and to then provide these with a porous titanium layer.

It is counted as belonging to the state of the art from DE 10 2015 111 918 to attach such a microporous layer onto a sintered metal plate by way of plasma injection in a vacuum. Plasma injecting under vacuum is technically complicated and expensive and can lead to layer thicknesses which are different in area.

Furthermore, it is counted as belonging to the state of the art to deposit such a porous layer which consists of titanium by way of thermal injection or with a 3D printing method. Concerning both methods, the layer thickness of the porous layer is not uniform due to the linear guidance on deposition.

### SUMMARY

Against this state of the art, it is an object of the invention to improve a method of the known type for manufacturing a porous transport layer for an electrochemical cell, in particular for the oxygen side, i.e. anode side of a PEM electrolyzer.

According to the invention, this object is achieved by a method with the features of the invention. Advantageous configurations of the invention are specified in this disclosure including the description and the drawings.

Concerning the method according to the invention for manufacturing a porous transport layer for an electrochemical cell, for example for a battery, for a fuel cell or for an electrolyzer, in particular for an electrolyzer of the PEM construction type, a metal which is to form part of the transport layer, thus for example titanium, as a metal powder is mixed with a binder and is subsequently shaped out into an extensive element or is deposited onto a carrier foil. The extensive element which is formed from the metal powder and a binder, or the carrier foil which is provided with the metal powder is brought to bear on a porous metal layer or on a green part of a porous metal layer. Alternatively, the extensive element can also be deposited directly on a porous metal layer or a green part or brown part of a porous metal layer. The binder and the possibly present carrier foil are subsequently removed and the remaining brown part layer is sintered or, by way of diffusion welding connected, to the porous metal layer or the brown part of the porous metal layer. Concerning both variants, an intimate material interconnection results, concerning which a microporous metal layer is connected onto a porous metal layer into a component.

The basic concept of the method according to the invention is to provide a porous metal layer as is basically counted as belonging to the state of the art and is applied for the manufacture of such a porous transport layer, with a fine, porous (microporous) metal layer by way of powder-like metal powder firstly being mixed with a binder. This binder can be a binding agent which consist of several materials, for example consisting of polyethylene and wax, in order in this manner to generate a material which analogously to MIM technology is denoted as a feedstock and which then can be processed further in an extruder or another suitable machine amid the effect of heat and pressure, such that a suitable shaping is possible.

According to the invention, the shaping is effected into an extensive element, thus for example into a thin foil, a thin extensive layer or however amid the aid of a carrier foil on which the thin layer is deposited. Herein, either this extensive element is shaped out into a self-supporting element such as for example a foil or is formed (as an extensive element) by way of a carrier foil as a layer (as an extensive element) on such or however is brought directly as a layer onto a porous metal layer of preferably the same material or onto a green part of such a porous metal layer. The binder and the possibly present carrier foil are typically subsequently removed by way of thermal release, alternatively or additionally by chemical release. The porous metal layer which then remains and the extensive element which is located thereon as a brown part—this is the metal part which remains from the foil/carrier foil after the removal of the binder and the carrier foil—are then connected into a component by way of sintering, i.e. by way of subjection to a high temperature and possibly additionally to pressure. This can alternatively be effected by way of diffusion welding.

If, as is advantageous, the porous metal layer is also manufactured of a metal powder and a binder, then the procedure of the removal of the binder as well as the subsequent sintering process of both layers, thus of the porous metal layer to be achieved as well as the extensive element which is arranged thereon or the parts which remain after the removing of the binder are then simultaneously sintered together. The extensive element which is to be formed and which in the finished product forms the later thin, microporous, electrically conductive and fluid-permeable layer for being brought to bear on the catalyzer surface can either be effected by way of manufacturing an intrinsically stable, i.e. self-supporting foil, by way of depositing a layer on a carrier foil or by way of deposition of a layer directly onto the porous metallic layer or a green part of the porous metallic layer if this is to be manufactured in the same manner.

If instead of shaping out a mixture consisting of metal powder and binder into a foil, metal powder and binder are deposited onto a carrier foil, e.g. a foil of polyethylene, then the binder and the carrier foil must firstly be removed by way of thermal and/or chemical treatment, whereupon a brown part layer consisting of fine metal powder then likewise remains, said layer being sintered together with the porous metal layer. Instead of sintering, these layers can also be connected by way of diffusion welding. This method has been known for some time and their parameters are to be selected in accordance with the material.

The method according to the invention permits an inexpensive and at the same time effective manufacture of porous transport layers given a comparatively low use of metal material. Herewith, a very uniform and at the same time particularly thin microporous layer can be deposited onto the porous metal layer and thus a thinly constructed porous transport layer which is highly effective with regard to the electrical connectivity and the fluid permeability can be formed. The sintering of the materials can possibly be additionally supplemented by way of pressure subjection additionally or before or and after the thermal treatment.

In particular, the method according to the invention is provided for a porous transport layer which is formed from titanium or a titanium alloy, but it is however to be understood that porous transport layers of other materials or metal alloys can be formed by the method according to the invention. Herein, what is decisive for the layer thickness is on the other the applied porous metal layer and on the other the grain size of the metal powder, which is specified in detail further below.

It is particularly advantageous if the mixture which is formed from metal powder with a binder is shaped out into a foil by way of extruding, thus amid the application of an extruder. Such extruders are known from plastic injection molding technology and are available in numerous variants. Herein, the thus shaped-out foil forms a green part whose binder is subsequently removed typically by way of thermal treatment, thus by way of heating, after the foil has been deposited on the porous metal layer or a green part or a brown part of the porous metal layer which then assumes the carrying function of the foil.

Alternatively, the shaping-out of the foil can be effected by way of continuous casting, wherein the foil can possibly be fed to a mechanical post-treatment, be it in the still warm or in the cold form, in order to effect a stretching or thinning effect by way of rolling.

Alternatively or additionally, the shaping-out of the foil according to a further development of the invention can be carried out by way of calendering. By way of processing the foil with a calender, the layer thickness can be further homogenized and furthermore a certain rolling effect can also be achieved with this method. The calendering can be effected subsequently to the extruding or continuous casting.

The manufacturing method according to the invention however can also be used whilst avoiding foil technology, be it the formation of a foil from metal powder and binder or the use of a carrier foil, on which metal powder with binder is deposited, if the metal powder which is mixed with a binder is not shaped out into a foil, but is deposited onto the porous metal layer with the screen printing method. It is to be understood that the binder which is used for the screen printing method can also be a binding agent other than is used for forming the foil. The temperature and viscosity are to be matched to one another such that this mixture of metal powder and binder can be deposited through a suitable finely meshed fabric onto the porous metal layer by way of a doctor blade and after the removal of the fabric this layer flows together into an homogenous as possible layer of the same thickness. Again, the binder is to be removed before the sintering, which can be effected by way of thermal and/or chemical subjection. Thus the pressing layer can be rinsed with a solvent before or after the thermal treatment, so that the diffusion processes are not later inhibited by contaminations of the binder given a later sintering.

Also whilst using the screen printing method, according to the invention one alternatively envisages, instead of depositing on the porous metal layer, accomplishing this on a green part of the porous metal layer, in order to then free the two layers together and simultaneously from the binder and to sinter the thus arising brown parts simultaneously and together. According to the invention, one can also envisage the extensive element which is deposited in the screen printing method being deposited on a brown part of the porous metal layer, and this makes particular sense if the two layers are manufactured using different binders. Furthermore, one should consider the fact that the grain sizes of the metal powder of the porous layer are significantly larger than those of the microporous layer, which is why the manufacturing method is to be controlled such that the layers are retained in their structure and are only connected to one another in the boundary regions.

The method according to the invention is particularly advantageously used for manufacturing a porous transport layer of titanium or a titanium-based alloy which comprises at least 95% by weight of titanium. A pure as possible titanium is advantageously used for the anode of the PEM electrolyzer. The porous metal layer can be formed by a sinter metal plate, a metal fabric and/or a metal felt. Such sinter metal plates are counted as belonging to the state of the art and are offered for example by the GKN group or the US American MOTT corporation. The application of a metal felt is particularly advantageous since it is offered e.g. by NV Bekaret S. A. for this purpose or is offered by the German Melicon GmbH.

In order on the one hand to ensure a low as possible material expense with regard to the microporous layer, but on the other hand to obtain a good electrical conductivity and contacting ability, as well as a high fluid permeability given a small layer thickness, it is advantageous to use metal powder which has a maximal grain size of smaller than 45 μm. Preferably, the maximal grain size is smaller than 20 μm or even more favorably smaller than 10 μm, which at present would be the smallest possible grain size which can be handled and which available on the market. Basically, an even smaller grain size would be desirable, but this cannot be realized according to the present state of the art.

For example, given a PEM electrolyzer, the microporous layer is envisaged to be brought to bear on a catalyzer layer which is arranged on a polymer electrolyte membrane. In order to here ensure a well conductive surfaced contact, according to a further development of the method according to the invention one envisages smoothing the surface of the porous transport layer at its side which is envisaged for being brought to bear on a catalyzer, thus the free surface of the microscopic layer, by way of grinding and/or rolling.

Alternatively or additionally to the smoothing, it can be advantageous to chemically roughen this surface, preferably by way of etching. In particular, the porosity in the surface region as well as an intimate, electrically conductive contact when the surface is brought to bear on catalyzer is ensured by way of this. Given a porous transport layer which is formed from titanium, such a pickling procedure can be effected for example by way of treatment with sulphuric acid.

In order to minimize the use of material and to keep the thickness of the porous transport layer as small as possible, it is advantageous to configure the foil which is shaped out from metal powder and binder in a thickness of 0.04 mm to 0.2 mm, preferably in a thickness of 0.04 mm to 0.1 mm. Herein, the minimal layer thickness is determined by the maximal grain size—the smaller the maximal grain size, the smaller can the layer thickness of the foil also be.

It is to be understood that the porous metal layer, if this is likewise manufactured from a mixture of metal powder and binder which are is shaped out e.g. into a self-supporting layer as a green part, concerning which the binder for forming the brown part is then removed and finally the interconnection of the metal power is effected by sintering. The porous metal layer has a grain size which lies significantly above that which is used for the manufacture of the microporous layer.

In order to improve the handling ability of the porous transport layer which is configured as thinly as possible, and which consists of the porous metal layer with the microporous layer which is deposited thereon, according to a further development of the invention one envisages welding this porous transport layer to a bipolar plate, in order to thus produce a component which is easily handled in the assembly process of an electrolyzer and which in particular can be applied in automated assembly processes. Such a bipolar plate can consist e.g. of titanium or titanium-coated stainless steel and is materially connected to the porous metal layer in an extensive or surfaced manner. It is to be understood that the extensive extension of the bipolar plate and transport layer are matched to one another.

The invention is hereinafter explained by way of the embodiment examples which are represented in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly simplified schematic sectioned representation showing the construction of electrolysis cell of a PEM electrolyzer;

FIG. 2 is a schematic sectioned representation showing the extruding of a foil which is formed from metal foil and binder;

FIG. 3 is an enlarged sectioned representation showing the construction of the foil;

FIG. 4 is an enlarged sectioned representation showing foil which is applied onto the porous metal layer;

FIG. 4a is an enlarged sectioned representation showing the foil which is applied onto a green part of the porous metal layer;

FIG. 5 is an enlarged sectioned representation showing the arrangement according to FIG. 4 after removing the binder;

FIG. 6 is an enlarged representation in section showing the porous transport layer on an upper surface after the smoothing;

FIG. 7 is an enlarged representation in section showing the surface of the layer after the roughening;

FIG. 8 is a schematic representation showing the depositing of the mass which consists of the metal powder and the binder, onto the porous metal layer in the screen printing method.

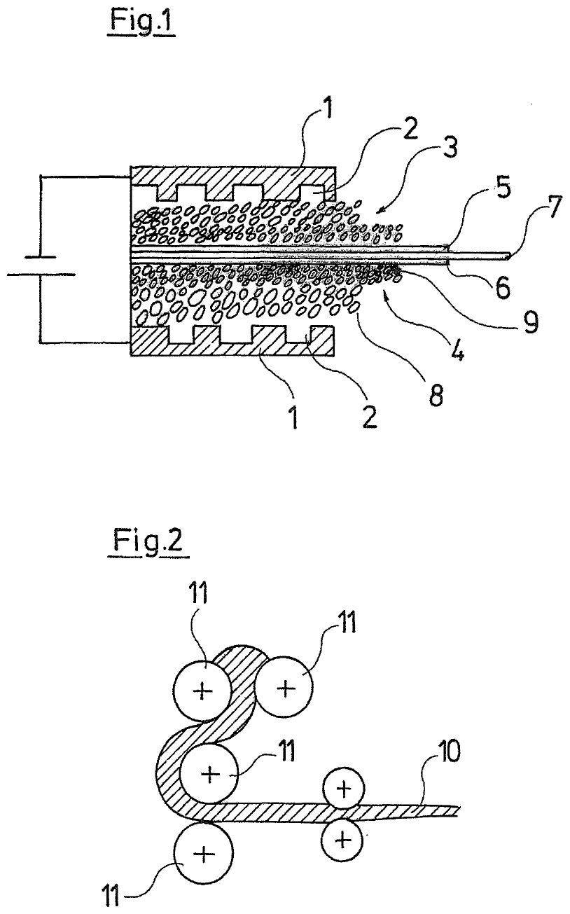

### DESCRIPTION OF PREFERRED EMBODIMENTS

Referring to the drawings, the basic construction of a PEM electrolyzer is represented in FIG. 1. The electrical voltage for creating hydrogen and oxygen from water is applied onto the outer bipolar plates 1 which comprise channels 2 for feeding the reactants of the water as well as for leading away the reaction products hydrogen and oxygen. The channels 2 of the bipolar plates 1 which are open to the inside of the electrolysis cell are covered by porous transport layers 3, 4 which are electrically conductive and liquid permeable. The porous transport layers 3 and 4 each bear on a catalyzer layer 5 and 6 respectively in an electrically conductive manner, said catalyzer layer being deposited onto a PEM 7. Concerning the electrolysis cell represented here for producing w hydrogen and oxygen from water, the anode-side transport layer 4 consists of titanium and the cathode-side transport layer 3 consists of graphite. The anode-side catalyzer layer 6 is formed from iridium oxide and the cathode-side catalyzer layer 5 of platinum. Such a construction is counted as belonging to the state of the art and is therefore not explained in detail.

Such an electrolysis cell is sealed off at the peripheral side, so that the necessary leading of fluid is ensured. A multitude of such electrolysis cells are arranged lying on one another as a stack (electrolysis stack), in order to form a powerful but compactly constructed electrolyzer. Hereinafter, the anode-side porous transport layer and its manufacturing method are explained, wherein this porous transport layer 4 can also serve for other electrochemical applications, and hence the application as an electrolyzer is cited only by way of example.

The porous transport layer 4 which is formed from titanium consists of a porous metal layer 8 in the form of a felt layer 8 which is formed from titanium fibers and which is gas permeable and conductive. This felt layer 8 is 0.25 mm thick and forms the carrier of the porous transport layer 4, on which a microporous metal layer 9 is deposited, said metal layer together with the metal layer 8 forming the anode-side porous transport layer 4 of titanium.

The microporous metal layer 9 which ensures the electrical connection between the porous transport layer 4 and the catalyzer layer 6 which bears thereon is effective on the one hand for the surfaced electrical connection of the bipolar plate 1 to the catalyzer layer 6 and on the other hand due to its micro-porosity ensures an intimate exchange of reactants as well as of the oxygen which is separated away at this side.

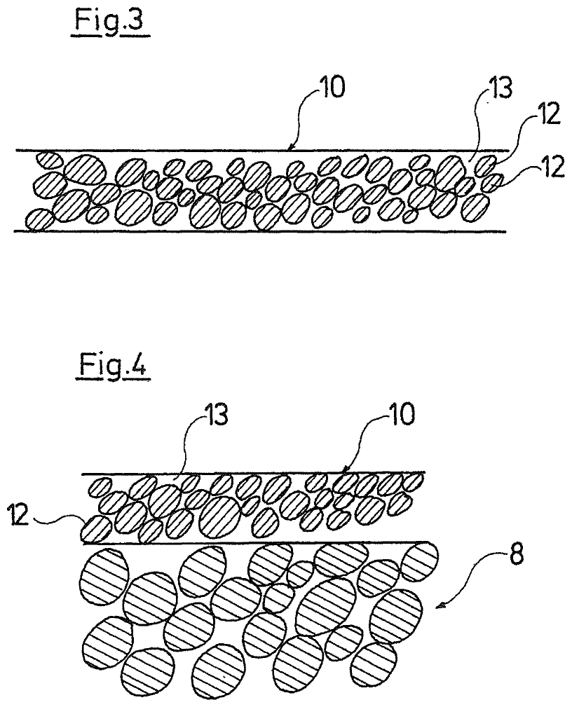

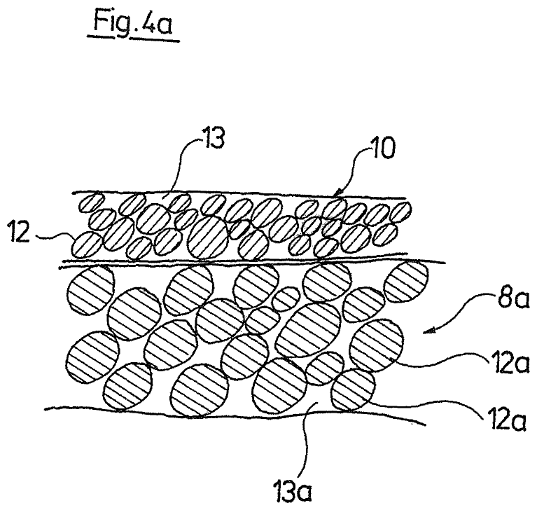

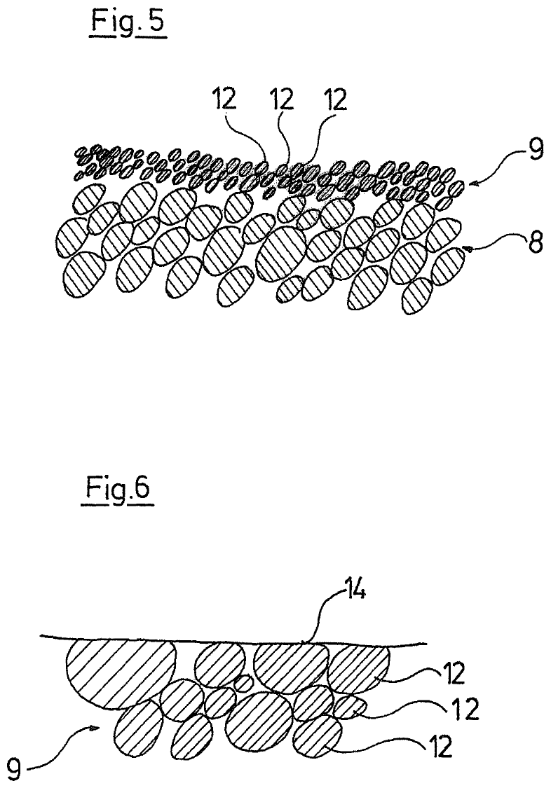

The microporous metal layer 9 is manufactured by way of fine metal powder, in this case titanium powder, with a maximum grain size of 10 μm being used with a binding agent for example of polyethylene and wax. Herein, the metal powder and the binder which is formed form polyethylene and wax are intensively mixed and granulated into a feedstock. This granulate is liquefied by way of an extruder and by way of a calender 11 is processed into a foil (an extensive element) 10 which has a thickness of 0.1 mm. This foil 10 forms the green part in this powder injection molding method and this foil 10 is shown in FIG. 3 in section and is subsequently deposited onto the porous metal layer 8, so that the arrangement which is evident from FIG. 4 results.

As the representation according to FIGS. 3 and 4 illustrate, the foil 10 consists of metal grains 12 which are encompassed by the binder 13 or are connected to one another by this. The porous metal layer 8 likewise consist of titanium and forms the carrier for the foil 10 which lies thereon. A release occurs in this arrangement, i.e. in a first thermal process the formation which consists of porous metal layer 8 and foil 10 is heated to such an extent that the binder 13 is removed and the metal grains 12 come to bear on the porous metal layer 8. The metal grains 12 now form a brown part which together with the porous metal layer 8 is subjected to a further heat treatment of a higher temperature (sintering), so that the metal grains 12 sinter amongst one another as well as to the porous metal layer, i.e. are unified and compacted into their final geometric and mechanical characteristic. Herein, a material-fit connection of the metal grains 12 as well as to the porous metal layer 8 takes place. This interconnection can also be formed by way of diffusion welding instead of by way of sintering. The thus formed porous transport layer 4 is formed by the porous metal layer 8 with the felt structure and the microporous metal layer 9 while lies thereabove. The latter is smoothed on its surface by way of rolling, so that a surface 14 as is represented schematically in FIG. 6 results. The surface smoothing can possibly be effected by way of grinding or by way of a combination of these machining methods. It serves for ensuring an as complete-surfaced as possible bearing contact of the thus formed porous transport layer 4 on the catalyzer layer 6.

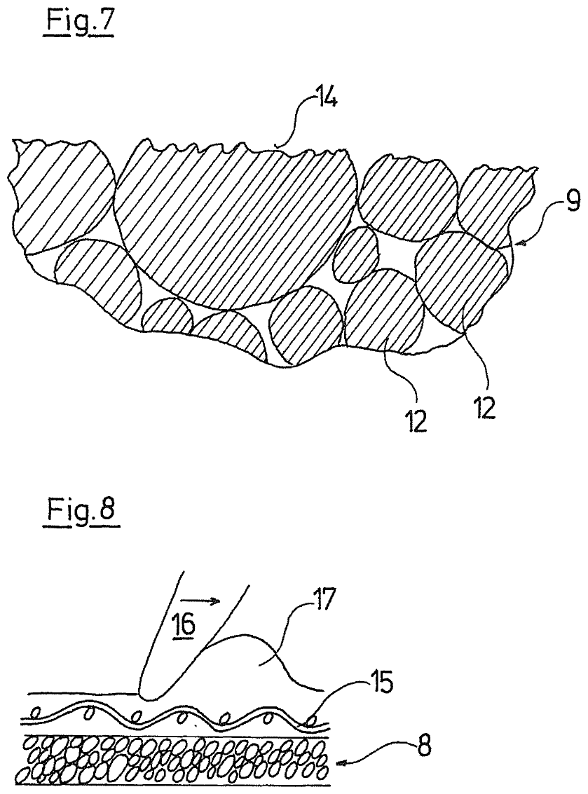

In order to ensure an intimate interconnection and thus an electrically well conductive contact between the microporous metal layer 9 and the catalyzer layer 6, the surface 14 of the microporous metal layer 9, as is represented in FIG. 7, is microscopically roughened by way of pickling.

In the manufacturing method which are described above, a foil (extensive element) 10 consisting of metal grains 12 and binders 13 is manufactured as a green part in an injection molding method. Alternatively, this can be replaced by way of a foil (a extensive element) which is formed e.g. of polyethylene being used as a carrier foil which is provided with metal powder 12 and binder 13, wherein this foil (extensive element) which is provided with the metal powder-binder mixture is deposited onto the porous metal layer 8 instead of the foil (extensive element) 10 which is represented in FIG. 4. The further manufacturing method is effected as previously described.

An alternative manufacturing method for producing and depositing the microscopic layer 9 specifically in the screen printing method is represented by way of FIG. 8. There, a fabric 15 as a template is applied onto the porous metal layer 8 and instead of the otherwise deposited printing ink, here a pasty/fluid material 17 consisting of metal grains 12 and a binding agent are subsequently deposited by way of a doctor blade 16. After depositing the pasty material 17, the fabric 15 is removed and the pasty/fluid material 17 is brought into solidification by way of thermal action or e.g. evaporation of a solvent, wherein the consistency of the pasty/fluid material 17 is set such that a certain distribution is still effected after the removal of the fabric 15 so that an as homogeneous as possible smooth surface forms. Hereinafter, as with the initially described method, by way of a first thermal treatment the binding agent is then removed and subsequently by way of sintering or diffusion welding an interconnection of the metal grains 12 amongst one another as well as with the porous metal layer 8 is produced. The surface treatment steps can be effected as described above. Furthermore, the thermal removal of the binding agent can be replaced by a chemical removal or a combination of both.

Concerning the aforedescribed embodiment examples, the microporous metal layer 9 is continuously deposited on a porous metal layer 8, be it by way of applying a suitable foil 10 or a carrier foil which is provided with metal powder and binder or by way of a direct deposition of the mixture which is formed from the metal grains and the binder. As is represented by way of FIG. 4a, the porous metal layer 8 however can also be manufactured in an analogous manner as the microporous metal layer 9. It is to be understood that here a mixture of metal powder and binder is used, whose metal grains 12 are significantly larger than the metal grains 12 of the microporous metal layer and whose binder 13a can have the same composition or different composition than the binder 13. In FIG. 4a, a green part 8a of such a porous metal layer is represented, wherein this is machined together with the green part of the layer which lies above and which forms the later microporous metal layer 9, i.e. firstly the binder 13 and 13a is removed from both layers, so that a two-layered brown part which is formed from two brown parts results and this in the subsequent sintering procedure is sintered into the porous transport layer 4. This thus formed porous transport layer 4 is then usefully materially connected to the bipolar plate 1 e.g. by way of welding, so that an intrinsically stable, self-supporting component arises which in particular can be easily handled in an automated assembly process.

While specific embodiments of the invention have been shown and described in detail to illustrate the application of the principles of the invention, it will be understood that the invention may be embodied otherwise without departing from such principles.

What is claimed is:

1. A method for manufacturing a porous transport layer for an electrochemical cell, the method comprising:
mixing a metal, which is to form part of the transport layer, as a metal powder with a binder and subsequently shaping out the mixture into an extensive element or depositing the mixture onto a carrier foil as an extensive element;
bringing the extensive element to bear on a porous metal layer or on a green part or brown part of a porous metal layer;
removing the binder and/or the carrier foil to provide a remaining brown part layer; and
sintering the remaining brown part layer diffusion welding the remaining brown part layer to connect the remaining brown part layer to the porous metal layer or to the brown part of the porous metal layer.

2. A method according to claim 1, wherein the shaping-out of the extensive element into a foil is effected.

3. A method according to claim 2, wherein the shaping-out of the foil is effected by extruding.

4. A method according to claim 2, wherein the shaping-out of the foil is effected by way of continuous casting.

5. A method according to claim 2, wherein the shaping-out of the foil is effected by calendering.

6. A method according to claim 1, wherein the extensive element is deposited onto the porous metal layer or onto the brown part of the porous metallic layer in a screen printing method.

7. A method according to claim 1, wherein the porous metallic layer is formed by metal powder which is mixed with binder, wherein the green part is formed after the shaping-out and the binder is subsequently removed and the formed brown part is sintered.

8. A method according to claim 7, wherein the removing of the binder and/or the sintering is effected simultaneously with that of the extensive element.

9. A method according to claim 1, wherein the metal is titanium or an alloy which is based at least to 95% by weight on titanium.

10. A method according to claim 1, wherein the porous metal layer is formed by a sinter metal plate, a metal fabric and/or metal felt.

11. A method according to claim 1, wherein the metal powder with a maximal grain size smaller than 45 μm, is used for manufacturing the extensive element.

12. A method according to claim 1, wherein a surface of the porous transport layer at a side for bearing on a catalyzer is smoothed by way of grinding or rolling.

13. A method according to claim 1, wherein a surface of the porous transport layer on a side for bearing on a catalyzer is roughened chemically.

14. A method according to claim 1, wherein the extensive element foil is formed in a thickness of 0.04 mm to 0.2 mm.

15. A method according to claim 1, wherein the transport layer is welded to a bipolar plate.

16. A porous transport layer, manufactured according to a method comprising:
mixing a metal, which is to form part of the transport layer, as a metal powder with a binder and subsequently shaping out the mixture into an extensive element or depositing the mixture onto a carrier foil as an extensive element;
bringing the extensive element to bear on a porous metal layer or on a green part or brown part of a porous metal layer;
removing the binder and/or the carrier foil to provide a remaining brown part layer; and
sintering the remaining brown part layer or diffusion welding the remaining brown part layer to connect the remaining brown part layer to the porous metal layer or to the brown part of the porous metal layer.

17. A porous transport layer according to claim 16, wherein the shaping-out of the mixture, into the extensive element forms a foil.

18. A porous transport layer according to claim 17, wherein the shaping-out of the foil is effected by extruding.

19. A porous transport layer according to claim 17, wherein the shaping-out of the foil is effected by way of continuous casting.

20. A porous transport layer according to claim 17, wherein the shaping-out of the foil is effected by calendering.
